(19) United States
(12) Patent Application Publication
(10) Pub. No.: US 2012/0042795 A1
(43) Pub. Date: Feb. 23, 2012

(54) METHOD AND APPARATUS FOR PRINTING ON A SUBSTRATE

(75) Inventor: Christopher S. Walker, Overland Park, KS (US)

(73) Assignee: PRECO, INC., Lenexa, KS (US)

(21) Appl. No.: 13/214,200

(22) Filed: Aug. 21, 2011

Related U.S. Application Data
(60) Provisional application No. 61/376,090, filed on Aug. 23, 2010.

(51) Int. Cl. B05C 17/04

(52) U.S. Cl. 101/123; 101/129

(57) ABSTRACT

A screen printing apparatus and method for applying paste to a substrate while agitating the paste through vibration or pulsating of one or more pulse sources. The screen printing apparatus may comprise a support structure including a frame, a stencil supported by the frame, a squeegee configured to contact the stencil and transfer the paste through apertures of the stencil, and at least one pulse source attached to the support structure and configured to agitate the paste on the stencil. The pulse sources may be configured to attach to and vibrate the frame, squeegee, or other components contacting the paste. Some of the pulse sources may vibrate in different directions relative to each other. In some embodiments of the invention, the pulse source may be configured to be directly inserted or immersed in the paste resting on the stencil during various steps of the printing method.

### RELATED APPLICATIONS

This non-provisional patent application claims priority benefit to earlier-filed U.S. provisional patent application titled “Method and Apparatus for Enhancing the Attributes of a Printed Composition” Ser. No. 61/376,090, filed Aug. 23, 2010, hereby incorporated in its entirety by reference into the present application.

### BACKGROUND

1. Field

The present invention relates generally to screen printing or stencil foil plate printing application of pastes, inks, or other print compositions used for flexible circuitry, photovoltaics, biosensors, or graphical/visual applications.

2. Related Art

Screen printing is the process by which a suitable paste, ink, or printable material is transferred to a substrate through a mesh containing a stencil design in order to create a picture or pattern.

Screen printing or stencil printing generally provides a greater volume of paste coating thickness, which can be varied intentionally in its range of thickness better than other traditional plate-based paste or ink transference methods. Screen printed paste deposit thickness is determined largely by the selection of the fabric mesh and often the stencil thickness of the pattern.

One method of screen printing or stencil printing employs a nominal separation distance of the bottom side of a screen stencil to the top side of a substrate. In its static condition, this distance is known in the art as “off-contact” or “snap.” A mesh stencil in an off-contact condition is deformed intentionally by a squeegee that is thrust into the mesh, deflecting it toward the substrate. The squeegee tool applies simultaneous downward pressure and wiping action to the screen stencil, so that intimate contact is made between the squeegee, the screen stencil, and the substrate, which is typically supported by a table or platen. The wiping action of the squeegee delivers a paste to the stencil apertures or openings, and the screen or stencil plate separates back to its original offset from the paste and substrate during or after the print squeegee stroke.

Another method of printing uses a foil-based stencil plate with apertures formed therethrough in a desired pattern or design, allowing the passage of a paste to a substrate during the downward pressure and wiping action of a squeegee. In this method, the stencil plate is rigid and completely in contact with the area of the substrate to which the paste is applied. After the squeegee is wiped across the stencil design, the squeegee and stencil plate are separated from the substrate.

Both of the aforementioned stencil printing methods are performed with a planar platen as a support for the substrate and in the trade are generally known as flatbed printing. Another method supports the substrate on a rigid cylinder so that a squeegee, stencil, and the substrate contact the tangential point of the rigid cylinder. In this method, the squeegee typically remains stationary during printing, and the printing frame holding the screen stencil or stencil plate reciprocates to create the wiping action and coating action of the squeegee and floodcoater. The rigid cylinder holds the substrate with vacuum and, depending on its design, either reciprocates back-and-forth or stops intermittently in its forward motion, in conjunction with the movement of the substrate. This arrangement is generally known in the trade as cylinder press screen printing.

In another screen printing method, the screen mesh and stencil pattern or a stencil plate can be in the form of a cylinder with an internal squeegee. The internal squeegee contacts an internal surface of the cylindrical stencil and the cylindrical stencil rotates in conjunction with a substrate being fed between and at a tangential point of the cylindrical stencil and a rigid support cylinder. In this method, the squeegee typically remains stationary and has no transitional movement; the wiping action is caused by the cylindrical stencil's forward rotation. This arrangement is generally known in the trade as rotary screen printing.

In all of the above methods, a substrate, on which paste will be transferred or printed, may be introduced to the printing process either as a sheet, or as a continuous web of material. In some screen printing methods, the substrate is a discrete three-dimensional object versus a sheet that is placed against a platen. For example, a cylindrical substrate such as a bottle may serve a dual purpose as both substrate and its cylindrical support surface.

Print compositions, paste, or ink used in screen printing are made up from a number of ingredients, such as a functional load, pigment, dye, mordant, binder, catalyst or other modifiers. Each paste mixture exhibits different flow characteristics or viscosity depending on the nature of the initial mixture of assembled compounds or elements. Additionally, a print composition may be thixotropic in nature. That is, paste may change in its viscosity due to shearing or deforming that occurs in the process of printing.

Paste formulated for a screen printing or stencil plate printing process is intended to permit good flow characteristics for printability. However, the intention also is for the paste to exhibit static characteristics of maintaining a modulus of rigidity after the application of the paste has been completed.

In general, a paste designed for satisfying both the printability and the finished printed body rigidity requirements often has difficulty achieving both conditions well. A paste designed for fluidity to provide good printability tends to continue to flow out or sustain its confluence, contrary to body rigidity needs. This means that these pastes, once printed, have difficulty keeping a crisp line definition, and are subject to slumping, thereby reducing the height of the trace while widening its base. This condition adversely affects many production scenarios.

Conversely, a paste designed primarily for keeping a well-defined aspect ratio—the height of a printed line or trace in respect to its width—often does not fill stencil cavities well due to its resistance to shearing, and subsequently does not transfer consistently to a substrate.

Accordingly, there is a need for improved methods of screen or stencil printing that overcome the deficiencies of the prior art.

### SUMMARY

Embodiments of the present invention provide a screen printing apparatus for applying paste to a substrate and agitating the paste during application thereof. The screen printing apparatus may comprise a stencil having apertures formed therethrough, a squeegee, and at least one pulse source. The squeegee may have an end portion configured to contact the stencil in order to transfer the paste through the apertures of the stencil via actuation of the stencil relative to the squeegee or actuation of the squeegee relative to the stencil while maintaining contact between the squeegee and the stencil. The pulse source or sources may be configured to pulsate or vibrate the paste on the stencil at a predetermined frequency and amplitude.

In accordance with another embodiment of the invention, a screen printing apparatus for applying paste to a substrate may include a frame, a stencil supported by the frame, a squeegee, a support surface positioned under the stencil to support the substrate between the stencil and the support surface, and at least one pulse source configured for agitating the paste applied onto the stencil. The stencil may have one or more apertures formed therethrough and the squeegee may be actuatable toward and away from the stencil and across at least a portion of the stencil. Specifically, the squeegee may be configured to press into the stencil and wipe across the stencil, transferring at least a portion of the paste through the apertures of the stencil. The pulse source or sources may be fixedly or actuatably attached to the frame, stencil, squeegee, and/or support surface and configured to agitate the paste applied onto the stencil. The pulse source may agitate the paste by pulsating or vibrating the component to which it is attached or by being directly inserted into the paste resting on the stencil.

In accordance with yet another embodiment of the invention, a method for screen printing may comprise the steps of inserting a substrate between a support surface and a first surface of a stencil, applying paste to a second surface of the stencil, and agitating the paste on the second surface of the stencil via vibration or pulsating of a pulse source. The method may also comprise the steps of placing a squeegee in contact with the paste and the second surface of the stencil and wiping the squeegee across at least a portion of the second surface of the stencil via actuation of the squeegee and/or the stencil relative to each other, thereby deflecting the stencil to the substrate to transfer the paste to the substrate.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a printing apparatus constructed in accordance with an embodiment of the present invention;

FIG. 2 is a perspective view of an alternative embodiment of the printing apparatus of FIG. 1 having one or two squeegees;

FIG. 3 is a cross-sectional view of the printing apparatus of FIG. 1 illustrating an off-set distance between a stencil and a support surface of the printing apparatus and further illustrating paste being spread by a flood coater across a stencil of the printing apparatus;

FIG. 4 is a cross-sectional view of the printing apparatus of FIG. 3, illustrating a squeegee of the printing apparatus actuated to deflect the stencil to a substrate;

FIG. 5 is a cross-sectional view of the printing apparatus of FIG. 2 with no off-set distance between a stencil plate and the support surface, illustrating the squeegee of the printing apparatus wiping the paste into apertures of the stencil plate onto the substrate;

FIG. 6 is a cross-sectional view of the printing apparatus of FIG. 5 after paste is applied to the substrate, illustrating the frame and stencil being separated from the substrate;

FIG. 7 is a cross-sectional view of an alternative embodiment of the printing apparatus constructed according to an embodiment of the present invention with a rotary support surface; and

FIG. 8 is a cross-sectional view of another alternative embodiment of the printing apparatus constructed according to an embodiment of the present invention with a rotary stencil, a rotary support surface, and a substantially stationary squeegee.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

As illustrated, embodiments of the present invention include a screen printing apparatus 10 for applying paste 12 to a substrate 14. The printing apparatus 10 is configured to control or optimize the flow of the paste 12 during printing. The paste 12 may include various pastes, inks, viscoelastic material, viscous fluids, elastic solids, or other print compositions used for flexible circuitry, photovoltaics, biosensors, graphical/visual applications, or any other printing applications. Other ingredients of the paste 12 may include functional load, pigment, dye, mordant, binder, catalyst or other modifiers. The substrate 14 may be plastic, metal, paper, cloth, or any printable two-dimensional or three-dimensional surface known in the art.

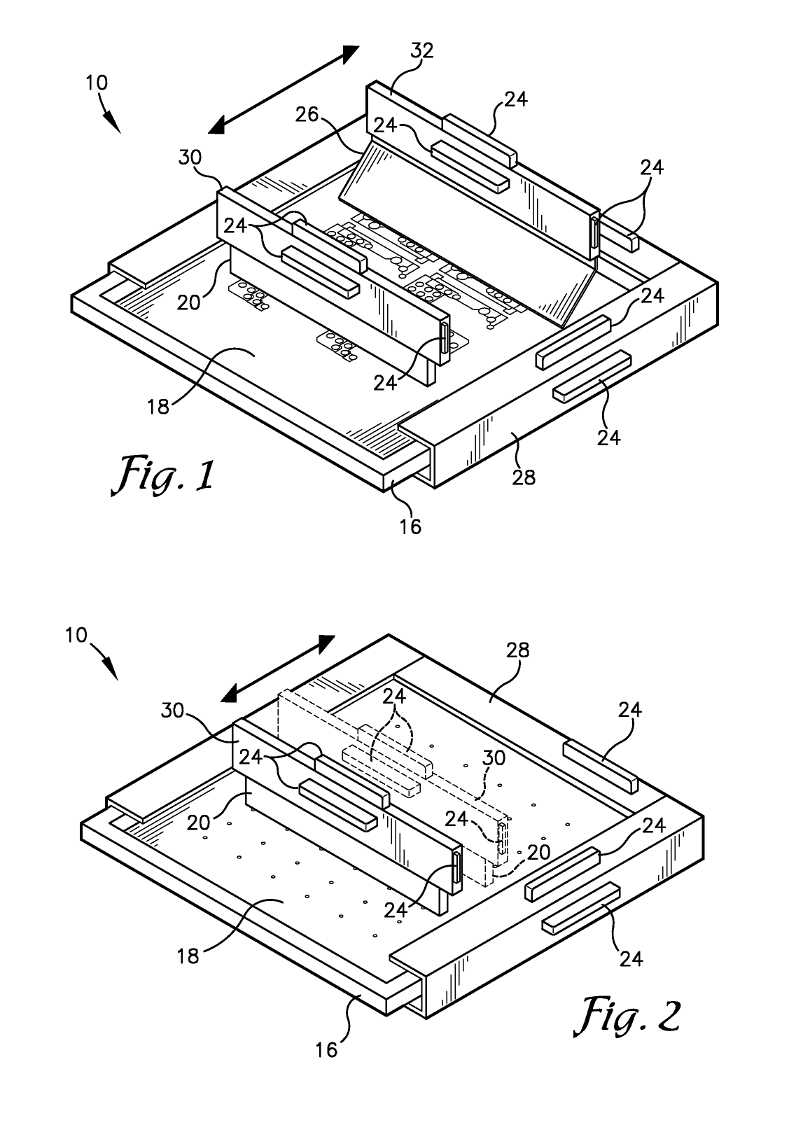

In general, the printing apparatus 10 may comprise a support structure, a frame 16 connected to or part of the support structure, a stencil 18 supported by the frame 16, a squeegee 20 configured to deliver the paste 12, a support surface 22 to support the substrate 14, and one or more pulse sources 24 configured to agitate the paste 12 during printing. In some embodiments of the invention, as illustrated in FIGS. 1, 3, 4, and 7, the printing apparatus 10 may also comprise a flood coater 26 configured to evenly apply the paste 12 across the stencil 18. Furthermore, the printing apparatus 10 may comprise and/or be communicably coupled with a control system and/or various actuation devices configured to actuate one or more movable components of the printing apparatus 10.

The support structure may fixedly or actuatably connect various components of the printing apparatus 10 with each other and may include the frame 12, the support surface 22, and/or a support carriage (not shown). Furthermore, various elements of the support structure may be fixedly or removably attached with each other, such as the frame 16 which may be slidably inserted into a frame holder 28, as illustrated in FIG. 1 and later described herein. Components of the support structure may also be actuatably attached with each other, such as the frame 16 being actuatable toward and away from the support surface 22 and/or actuatable back and forth in co-planar relationship with the support surface 22 in some embodiments of the invention.

The support carriage may be configured to suspend various components of the printing apparatus 10 above the stencil 18 and/or the support surface 22, such as the squeegee 20, flood coater 26, and/or at least some of the pulse sources 24. The support carriage may comprise various actuation devices, as described below, such as tracks, motors, and the like by which the squeegee 20 and the flood coater 26 may be actuated toward and away from the stencil 18 and/or back and forth across a width or length of the stencil 18. Furthermore, in some embodiments of the invention, at least some of the pulse sources 24 may be actuatably coupled to the support carriage or some other part of the support structure. For example, the pulse sources 24 may be independently actuated or actuated in cooperation with the squeegee 20 and/or the flood coater 26, as later described herein.

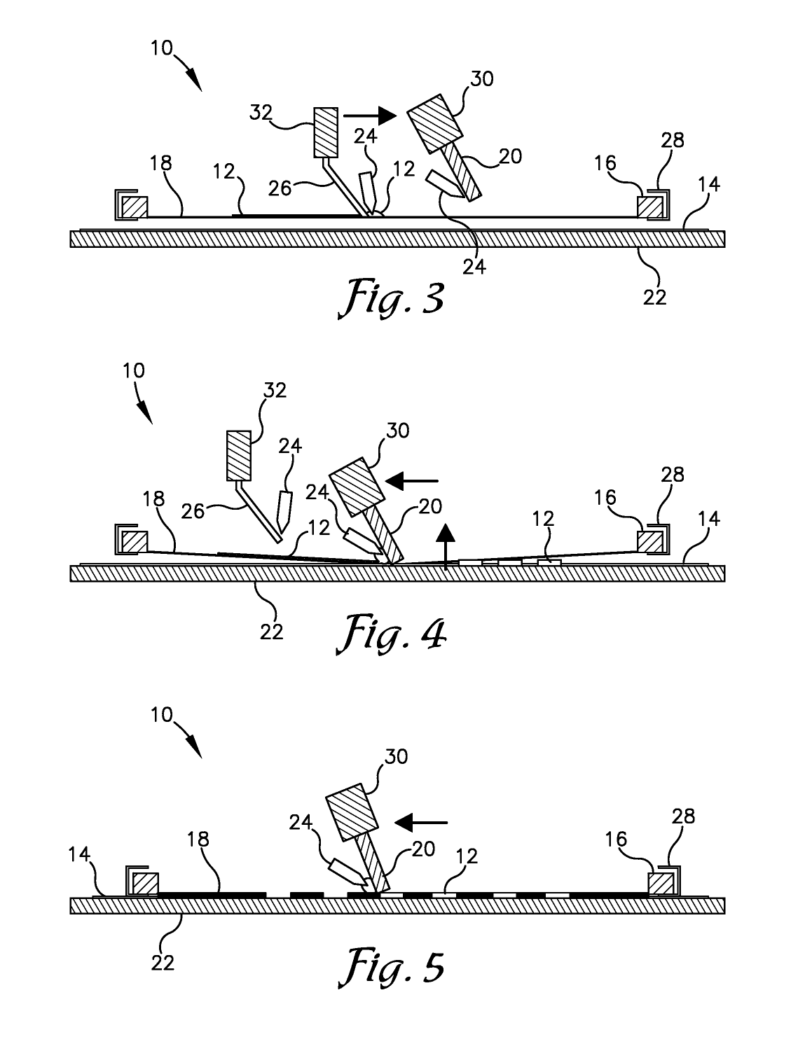

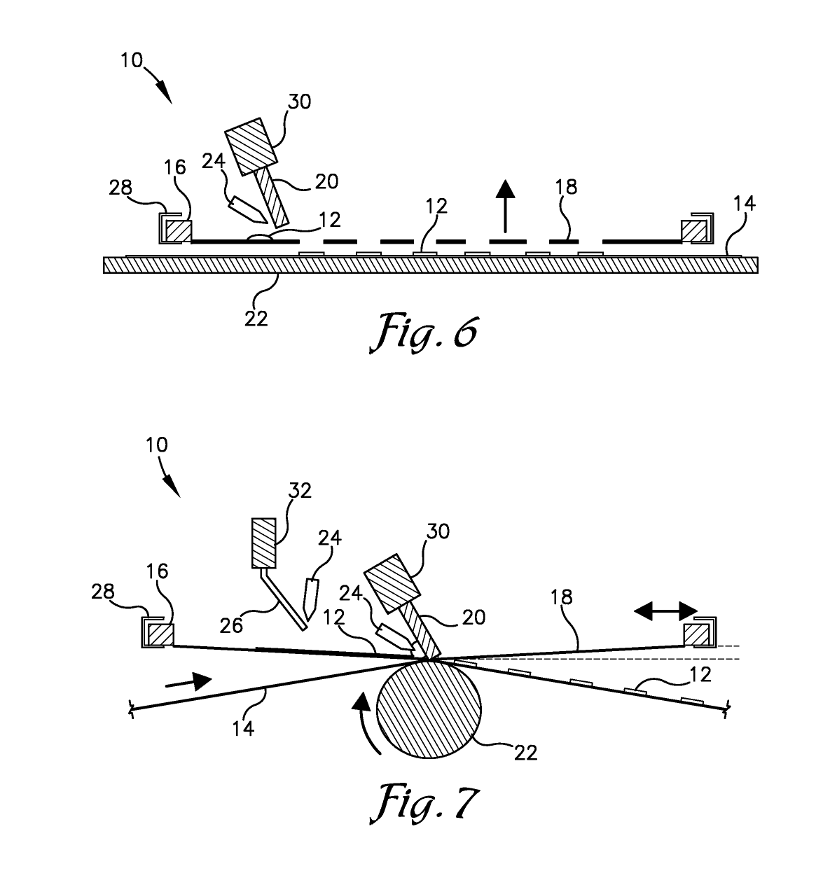

The frame 16, as illustrated in FIGS. 1-7 may be any support structure to which the stencil 18 is secured. For example, the frame 16 may extend around and attach to a periphery edge of the stencil 18. The frame 16 may be supported an offset distance above the support surface 22, as in FIGS. 3, 4, and 7, or may be placed on or supported by the support surface 22, as in FIGS. 5 and 6. In some alternative embodiments of the invention, as illustrated in FIG. 8, the frame 16 may be substantially cylindrical and rotatable, may be secured to or integrally formed with the stencil 18, and may be manually or automatically rotatable, such as by way of the control system. In some embodiments of the invention, the frame 16 may be fastened from above and thereby suspended over the substrate 14.

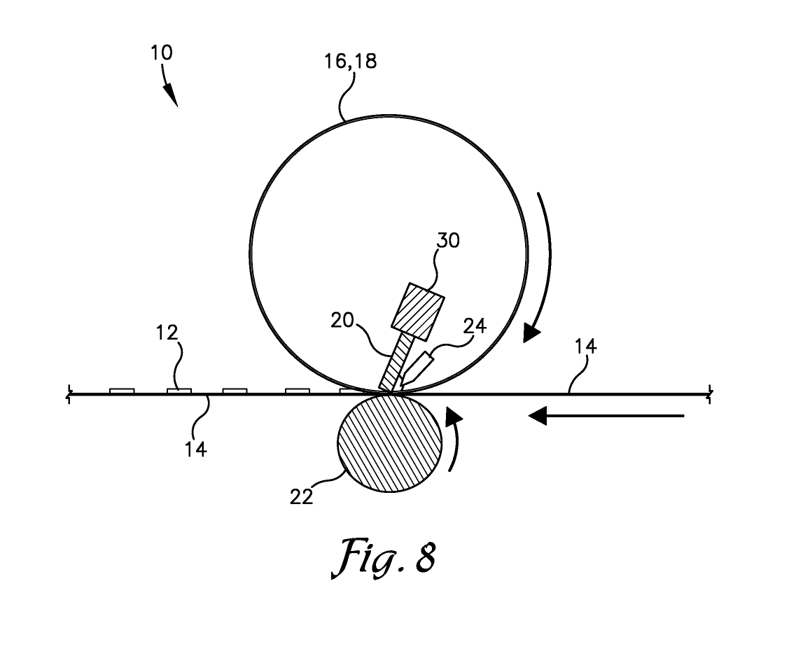

In some embodiments of the invention, as illustrated in FIG. 1, the frame 16 may further be supported by the frame holder 28 configured to receive the frame 16. For example, different frames 16 supporting different stencils 18 may be exchanged within the frame holder 28 to produce different print patterns. The frame holder 28 illustrated in FIG. 1 has a tray-like configuration such that the frame 16 may be slid therein. The frame holder 28, frame 16, and/or stencil 18 may be secured at or actuated to a particular offset or off-contact distance apart from the squeegee 20 and/or the flood coater 26 for printing. Alternatively, the printing apparatus 10 may be configured to actuate the squeegee 20 and/or the flood coater 26 to a particular offset distance apart from the frame holder 28, frame 16, and/or stencil 18. In some embodiments of the invention, as illustrated in FIG. 7, the frame 16 and/or frame holder 28 may be actuatable back and forth from side to side or end to end in a substantially horizontal plane or in a plane substantially co-planar or tangential to the support surface 22, either manually or automatically via the control system and/or actuation devices.

The stencil 18 or imaged stencil may be a sheet of material having apertures formed therethrough to allow passage of the paste 12 in select locations onto the substrate 14. For example, the stencil 18 may be an impermeable or paste-blocking material with one or more apertures formed therein. The apertures may have any desired shape, size, design, or configuration to produce an intended design onto the substrate 14. In some embodiments of the invention, the impermeable paste-blocking material may be supported on a meshed screen, configured to allow the paste 12 to pass therethrough. Alternatively, mesh threads or other intersticed matrix support materials may otherwise be attached to or integral with the impermeable sheet of material and transverse the apertures thereof. In some embodiments of the invention, the stencil 18 may comprise mesh threads or any intersticed matrix support material with portions thereof made impermeable in order to block the paste 12, so that the paste 12 only passes through areas of the stencil 18 not made impermeable (i.e., the apertures), as illustrated in FIG. 1. For example, the stencil may comprise a mesh or intersticed matrix support in which a layer for blocking passage of the paste 12 is developed, grown, electroformed, or embedded to create a desired stencil pattern. In some embodiments of the invention, the stencil 18 may be made of metal, polymer foil, silk, steel, nylon, and/or polyester, as well as other woven materials and may be stretched over or otherwise held taut by the frame 16. In some embodiments of the invention, the stencil 18 may be a foil or metal stencil plate, which is etched, laser cut, and/or electroformed to create the desired apertures therethrough, as illustrated in FIGS. 2, 5, and 6.

The squeegee 20 may be any blade or rake configured to push or pull the paste 12 across the stencil 18, pressing the stencil 18 against the substrate 14 and/or support surface 22. For example, the squeegee 20 may be a rubber blade, a plastic blade, a metal blade, a ceramic blade, or any other blade configured for pushing or pulling paste or ink over a surface and/or deflecting the stencil 18 into intimate contact with the substrate 14, as later described herein. Specifically, the squeegee 20 may be made of an elastomer material, a metal material, a ceramic material, polymeric resins, and/or plastics. In some embodiments of the invention, the squeegee 20 may be secured to a squeegee holder 30, as illustrated in FIGS. 1-8. The squeegee 20 and/or squeegee holder 30 may be actuatable to move toward and away from the stencil 18 and/or to move across a width and/or a length of the stencil 18. For example, the squeegee 20 may be configured to be actuated toward the stencil 18 until the stencil 18 is pressed against the substrate 14, and then the squeegee 20 may be actuated across at least a portion of the stencil 18 while maintaining contact with the stencil 18, as illustrated in FIG. 4. In some embodiments of the invention, such as embodiments where the stencil 18 is a stencil plate, as illustrated in FIG. 2, there may be two or more squeegees 20 which may move in opposite directions in either concurrent or alternating print cycles. Actuation of the squeegee 20 and/or the squeegee holder 30 may be manual and/or automatic. For example, the control system may be configured to control the actuation of the squeegee 20 toward and away from the stencil 18 and back and forth across the stencil 18. The squeegee 20 and/or the squeegee holder 30 may be held in a skewed or oblique angle in relationship to its travel directions across the stencil 18, and this angle may be adjustable manually or automatically.

In other alternative embodiments of the invention, as illustrated in FIG. 7, the squeegee 20 may be actuatable toward the stencil 18 until the stencil 18 is deflected to the substrate 14. Substrate 14 may be fed between the stencil 18 and the support surface 22 while the squeegee 20 remains stationary. In yet another embodiment of the invention, as illustrated in FIG. 8, the squeegee 20 may be fixed throughout the printing process while the stencil 18 and/or the substrate 14 are actuated.

The support surface 22 may be a platen, table, or any other substantially planar support surface, as illustrated in FIGS. 1-6. Alternatively, the support surface 22 may be substantially cylindrical, as in FIGS. 7 and 8. The support surface 22 may have one or more holes (not shown) formed therethrough and configured to fix the substrate 14 in place on the support surface 22 via vacuum or suction. For example, vacuum may be applied on a first side of the support surface 22 while the substrate 14 is placed on a second side of the support surface 22, thereby suctioning the substrate 14 to the support surface 22 via the holes formed through the support surface 22.

The support surface 22 may be stationary or may be actuatable, thereby actuating the substrate 14 relative to the stencil 18 and/or the squeegee 20. In some embodiments of the invention, as illustrated in FIGS. 7 and 8, the support surface 22 may be a cylinder support configured to be rotated manually and/or automatically and to help feed the substrate 14 through the printing apparatus 10. For example, the control system may be configured to control a motor or another actuation device operable to rotate or otherwise actuate the support surface 22.

The flood coater 26 may be any apparatus or component configured to spread the paste 12 across the stencil 18. In some embodiments of the invention, the flood coater 26 may comprise and/or be supported by a flood coater holder 32. The flood coater 26 and/or the flood coater holder 32 may be made of an elastomer material, a metal material, a ceramic material, polymeric resins, and/or plastics. The flood coater 26 and/or flood coater holder 32 may be actuatable toward and away from the stencil 18 and/or length-wise and/or width-wise across the stencil 18. For example, the flood coater 26 may be configured to move toward and make contact with the paste 12 after it is applied onto the stencil 18, and then may be actuated across at least a portion of the stencil 18 in such a manner as to spread the paste 12 in an even or substantially even layer across a majority of the stencil 18. Actuation of the flood coater 26 and/or the flood coater holder 32 may be manual and/or automatic. For example, the control system may be configured to control the actuation of the flood coater 26 toward and away from the stencil 18 and back and forth across the stencil 18. The flood coater 26 and/or the flood coater holder 32 may be held in a skewed or oblique angle in relationship to its travel directions across the stencil 18, and this angle may be manually or automatically adjustable.

The pulse sources 24 may include one or more devices configured to agitate or excite the paste 12 to cause a controlled liquefaction and/or a mechanical response of dilatancy of the paste 12, thereby enhancing desired flow characteristics and transfer of the paste 12 through the stencil 18 onto the substrate 14. Specifically, the pulse sources 24 may vibrate or pulsate, thereby causing the vibration or pulsating movement of some of the printing apparatus components and/or the paste 12. Whether vibration or pulsing causes shear thickening or shear thinning of the paste 12 may depend on the characteristics or formulation of the paste. The pulse sources 24 may be an ultrasonic transducer device, an electromagnetic device, a piezoelectric device, and/or an electromechanical device operable to pulsate or vibrate at one or more frequencies and at one or more amplitudes. The pulse sources 24 may include various mechanical components, electronic components, and/or circuitry configured to control the vibrational frequency and amplitude thereof. Furthermore, the pulse sources 24 may be integrally and/or communicably coupled with the control system, which may be configured to turn the pulse sources 24 on and off and/or vary the frequency and/or amplitude of the pulse sources 24. The pulse sources 24 may be configured to vibrate at any frequency. However, in an example embodiment of the invention, at least some of the pulse sources 24 may vibrate at a frequency between approximately 15,000 Hz and 30,00 Hz, or more specifically between 20,000 Hz and 25,000 Hz. However, any frequency or amplitude may be used without departing from the scope of the invention. The amplitude and/or frequency of the pulse sources may be continuously variable or controlled substantially steplessly.

The pulse sources 24 may be attached to one or more of the support structure, frame 16, frame holder 28, squeegee 20, squeegee holder 30, flood coater 26, and flood coater holder 32, or any components attached to the printing apparatus 10. Additionally or alternatively, one or more pulse sources 24 may be placed in direct contact with the stencil 18 and/or the paste 12. For example, one of the pulse sources 24 may be inserted or immersed into the paste 12 during its deposit onto the stencil 18, as illustrated in FIGS. 3-6. The pulse sources 24 may be cooperatively actuatable along with the squeegee 20 and/or the flood coater 26 such that their corresponding pulse sources 24 make contact with the paste 12 simultaneously while the squeegee 20 and/or the flood coater 26 makes contact with the paste 12. Specifically, the pulse sources 24 may be fixed or actuatably attached to the support structure in a configuration that allows the pulse sources 24 to be actuated in cooperation with the squeegee 20 or flood coater 26, but in such a manner that the pulse sources 24 do not directly contact the squeegee 20 or the flood coater 26. For example, as illustrated in FIGS. 4, 5, and 7, one of the pulse sources 24 may be fixed proximate to, but in a spaced apart relationship with, an end of the squeegee 20 configured to contact the paste 12, such that the corresponding pulse source 24 contacts the paste 12 simultaneously when the end of the squeegee 20 contacts the paste 12 and/or the stencil 18. Likewise, as illustrated in FIG. 3, one of the pulse sources 24 may be fixed proximate to, but in a spaced apart relationship with, an end of the flood coater 26 configured to contact the paste 12, such that the corresponding pulse source 24 contacts the paste 12 simultaneously when the end of the flood coater 26 contacts the paste 12.

In some embodiments of the invention, at least some of the pulse sources 24 may be positioned and configured to vibrate in multiple directions or along multiple axes relative to each other. For example, as illustrated in FIGS. 1-2, a first one of the pulse sources 24 may be mounted to a first side of the squeegee holder 30 and configured to vibrate back and forth along an x-axis, a second one of the pulse sources 24 may be mounted to an end of the squeegee holder 30 and configured to vibrate back and forth along a z-axis, and a third one of the pulse sources 24 may be mounted to a top of the squeegee holder 30 and configured to vibrate back and forth along a y-axis. In this example, embodiment, the x-axis, z-axis, and y-axis may each be substantially perpendicular relative to each other. FIG. 1 illustrates a similar arrangement of pulse sources attached to the flood coater holder 32 and the frame holder 28, such that these components may also be vibrated along three different axes simultaneously or at pre-determined intervals during the printing process. Each of the pulse sources 24 illustrated in FIGS. 3-6, configured to make direct contact with the paste 12, may also be configured to simultaneously or sequentially vibrate along its corresponding axis direction during the printing process. This may be accomplished by a plurality of pulse sources 24 each configured to vibrate or pulsate along one particular axis. Alternatively, at least one pulse source 24 may be configured to sequentially vibrate along several different axes at different points during the printing process.

The control system may comprise any number or combination of controllers, circuits, integrated circuits, programmable logic devices such as programmable logic controllers (PLC) or motion programmable logic controllers (MPLC), computers, processors, microcontrollers, or other control devices and residential or external memory for storing data and other information accessed and/or generated by the printing apparatus 10. The control system may be coupled with the actuation devices and/or the pulse sources 24, to enable information to be exchanged between the various components of the printing apparatus 10 and to position and actuate components of the printing apparatus 10 for printing. The control system may be configured to implement any combination of the algorithms, subroutines, or code corresponding to method steps described herein. However, in alternative embodiments of the invention, at least some of the method steps described herein may be performed manually via physical actuation by a user of the printing apparatus 10.

The control system and computer programs described herein are merely examples of computer equipment and programs that may be used to implement the present invention and may be replaced with or supplemented with other controllers and computer programs without departing from the scope of the present invention. The features of the control system may be implemented in a stand-alone device, which is then interfaced to the printing apparatus 10 or components thereof. The control features of the present invention may also be distributed among the components of the printing apparatus 10. Thus, while certain features are described as residing in the control system, the invention is not so limited, and those features may be implemented elsewhere.

The control system may implement a computer program and/or code segments to perform some of the functions and method described herein. The computer program may comprise an ordered listing of executable instructions for implementing logical functions in the control system. The computer program can be embodied in any computer-readable medium for use by or in connection with an instruction execution system, apparatus, or device, and execute the instructions. In the context of this application, a “computer-readable medium” can be any means that can contain, store, communicate, propagate, or transport the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The actuation devices may include pneumatic actuation devices, electronic actuation devices, and/or mechanical actuation devices, such as various motors, gears, pistons, tracks, ball bearings, and/or any combination of pneumatic or electro-mechanical components. The actuation devices may be configured for actuating physical movement of the frame 16, frame holder 28, stencil 18, squeegee 20, squeegee holder 30, flood coater 26, flood coater holder 32, pulse sources 24, support carriage, and/or the support surface 22. For example, the squeegee 20 and/or squeegee holder 30 may be actuated and/or powered by a servo motor drive, an alternating current frequency-controlled motor drive, and/or a stepper motor drive. Furthermore, the support carriage may comprise one or more actuation devices configured for supporting and actuating the squeegee 20 and/or the flood coater 26.

As illustrated herein, the components of the printing apparatus 10 described above may be configured in a variety of arrangements. FIGS. 1-6 illustrate various embodiments of the printing apparatus 10 in a flatbed press configuration, with the stencil 18 being substantially planar and generally supported in a co-planar relationship with the support surface 22. FIG. 2 illustrates an embodiment of the invention using two squeegees 20. FIGS. 3 and 4 illustrate a flatbed press configuration with an offset distance provided between the substrate 14 and the stencil 18. Specifically, as illustrated in FIG. 3, the frame 16 may support the stencil 18 at a given offset distance from the substrate 14 before application of the squeegee 20. During printing, the stencil 18 illustrated in FIG. 3 may be deflected downward by the squeegee 20, traversing the offset distance to contact the substrate 14 on the support surface 22. FIG. 5 illustrates another flatbed press configuration with the frame 16 resting directly on the support surface 22 and/or holding the stencil 18 substantially directly against the substrate 14 in complete co-planar intimate contact during printing. FIG. 6 illustrates the upward movement of the frame 16 of FIG. 5 as it is being removed from the substrate 14 after printing.

FIG. 7 illustrates another embodiment of the printing apparatus 10 in a cylinder press configuration, with the support surface 22 being rotatable, the stencil 18 being substantially planar, the substrate 14 being fed between the support surface 22 and the stencil 18 during printing, and the frame 16 or frame holder 28 being movable along an axis substantially tangential to the support surface 22 during printing. FIG. 8 illustrates yet another embodiment of the printing apparatus 10 in a rotary press configuration, with both the stencil 18 and the support surface 22 being rotatable and the substrate 14 being fed therebetween during printing, while the squeegee 20 remains stationary.

In use, the printing apparatus 10 provides the advantage of controlling and influencing the flow of the paste 12 during the wiping action of the squeegee 20, during the coating action of the flood coater 26 on the stencil 18, and/or during the separation of the stencil 18 from the paste 12 and the substrate 14. Specifically, one or more of the pulse sources 24 may be actuated to pulse and/or vibrate during different steps of the printing processes and/or at different locations relative to the printing apparatus 10 and/or relative to the paste 12. The vibration or pulsing may cause the paste 12 to flow more freely and fill openings of the stencil 18 more completely than prior art printing methods. Furthermore, the vibration or pulsing may allow the paste 12 to release more freely from the stencil 18 to achieve whole and proper transfer of the paste 12 to the substrate 14. Once the paste 12 is on the substrate 14 and not in contact with any vibrating or pulsing elements, or once the pulse sources 24 are turned off, the paste 12 may return to its original state or desired default condition for further processing.

In some embodiments of the invention, as illustrated in FIGS. 1 and 3-4, a printing method or a method of applying the paste 12 to the substrate 14 may comprise the steps of placing the substrate 14 between the support surface 22 and the stencil 18, applying paste onto the stencil 18, then actuating the flood coater 26 toward the stencil 18. Once the flood coater 26 is a desired distance away from the stencil 18, such that the flood coater 26 contacts the paste 12, as illustrated in FIG. 3, the method may comprise the step of actuating the flood coater 26 across a width and/or length of the stencil 18, evenly spreading the paste 12 across the stencil 18. As the paste 12 is spread, it may fill or partially fill the apertures of the stencil 18. Next, the printing method may comprise the steps of actuating the flood coater 26 away from the stencil 18 and actuating the squeegee toward the stencil 18 until it deflects the stencil 18 to the substrate 14 resting on the support surface 22, as illustrated in FIGS. 4, 5, and 7.

Then the printing method may comprise the step of actuating the squeegee 20 to be wiped across a width and/or length of the stencil 18, placing the stencil 18 in intimate contact with the substrate and thereby delivering the paste 12 in the apertures of the stencil 18 to the substrate 14. Alternatively, the method may include the step of actuating the frame 16 and/or stencil 18 to be actuated relative to the squeegee 20, such that the paste 12 is passed through the apertures. Finally, the printing method may comprise the step of actuating the squeegee 20 and/or the stencil 18 to lift away from the substrate 14 and/or the support surface 22, as illustrated in FIG. 6.

In the example embodiment of the invention illustrated in FIG. 2, the method may include the steps of actuating both the first and second squeegees 20 sequentially across the same or different portions of the stencil 18. In the embodiments of the invention illustrated in FIGS. 7 and 8, the printing method may include the steps of feeding the substrate 14 via the rotating support surface 22 and/or any other feeding mechanisms known in the art, while the squeegee 20 remains substantially stationary, pressing into the stencil 18. In some embodiments of the invention, as illustrated in FIG. 8, the frame 16 may support and/or be integrally formed with the stencil 18 and the printing method may comprise the steps of placing the paste 12 within the cylindrically-shaped stencil 18, actuating the squeegee 20 to an inner surface of the stencil 18, and rotating the stencil 18/frame 16 and the support surface 22 by corresponding rotational speeds and directions to feed the substrate 14 therebetween or to allow the substrate to be fed therebetween.

The printing methods described above may also include a step of agitating the paste 12 with one or more of the pulse sources 24. The pulse sources 24 may be activated at any point during the printing process. For example, in one step of the printing method, as illustrated in FIG. 3, a first one of the pulse sources 24 may directly contact the paste 12 while the flood coater 26 is actuated to spread the paste 12 across the stencil 18. Additionally or alternatively, as illustrated in FIGS. 4, 5, 7, and 8, a second one of the pulse sources 24 may directly contact the paste 12 while the squeegee 20 is actuated across the stencil 18 to apply the paste to the substrate 14. Additionally or alternatively, as illustrated in FIGS. 1 and 2, one or more of the pulse sources 24 may contact and cause vibration of the frame 16, the frame holder 28, the squeegee 20, the squeegee holder 30, the flood coater 26, and/or the flood coater holder 32 in order to agitate the paste 12 during any one of the printing method steps described above.

The method and printing apparatus 10 described herein is beneficial in providing wholeness and integrity to printed paste designs. This method and apparatus also allows for the printing of finer, higher resolution lines or features associated with a well-defined stencil, and may permit a better defined profile or aspect ratio of the deposited paste. Another benefit to the above-described screen printing process is to permit a manufacturer of paste greater latitude of formulation parameters. An intentional and temporary change of state of the paste 12 may be designed into the formulation in order to satisfy the several stages of the printing process. Embodiments of the invention in which the pulse sources 24 are inserted directly into the paste 12 may be beneficial in that only the paste 12 itself is vibrated or agitated, and not the stencil 18 or components (such as the squeegee 20) directly contacting the stencil 18. Other benefits not described herein may also be realized through the use of the methods and the apparatus described herein.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A screen printing apparatus for applying paste to a substrate, the screen printing apparatus comprising:
a stencil having one or more apertures formed therethrough;
a squeegee having an end portion configured to contact the stencil and transfer the paste through the apertures of the stencil via actuation of the stencil relative to the squeegee or actuation of the squeegee relative to the stencil while maintaining contact between the squeegee and the stencil; and
at least one pulse source configured to pulsate or vibrate the paste on the stencil at a predetermined frequency and amplitude.

2. The screen printing apparatus of claim 1, wherein the stencil is a screen-printing stencil comprising a mesh or intersticed matrix support portions through which the paste may pass and paste-blocking portions, cooperatively forming a pattern in which the paste is applied to the substrate.

3. The screen printing apparatus of claim 1, wherein the pulse source is fixed relative to and in a spaced-apart relationship with the squeegee and in close proximity to the end portion of the squeegee, such that the pulse source directly contacts the paste on the stencil when the end portion of the squeegee directly contacts the stencil.

4. The screen printing apparatus of claim 1, wherein the pulse source is at least one of an ultrasonic transducer device, an electromagnetic device, a piezoelectric device, and an electro mechanical device configured for vibrating or pulsating.

5. The screen printing apparatus of claim 1, further comprising a flood coater actuatable toward and away from the stencil and actuatable across a surface of the stencil, such that the flood coater is operable to spread the paste on the stencil across at least a portion of the stencil.

6. The screen printing apparatus of claim 5, wherein the pulse source is fixed in a spaced-apart relationship in close proximity to an end of the flood coater configured to contact the paste on the stencil, such that the pulse source directly contacts the paste on the stencil when the end of the flood coater directly contacts the paste on the stencil.

7. The screen printing apparatus of claim 5, wherein the pulse source comprises at least two pulse sources both attached to one of the squeegee and the flood coater and configured to vibrate or pulsate in different directions than each other.

8. The screen printing apparatus of claim 1, wherein the screen printing apparatus is at least one of a rotary screen printing machine, a cylinder press screen printing machine, and a flatbed screen or stencil plate printing machine with the at least one pulse source attached thereto.

9. The screen printing apparatus of claim 1, further comprising a support structure to which at least one of the stencil, squeegee, and pulse source are attached, wherein the support structure comprises at least one of a frame supporting the stencil, a support carriage actuatably supporting the squeegee, and a support surface configured to support the substrate between the support surface and the stencil.

10. A screen printing apparatus for applying a paste to a substrate, the screen printing apparatus comprising:
a frame;
a stencil supported by the frame and having one or more apertures formed therethrough;
a squeegee actuatable toward and away from the stencil and across at least a portion of the stencil, such that the squeegee is configured to press into the stencil and wipe across the stencil, transferring at least a portion of the paste through the apertures of the stencil;
a support surface positioned under the stencil and configured to support the substrate thereon between the support surface and the stencil; and
at least one pulse source fixedly or actuatably attached to at least one of the frame, stencil, squeegee, and support surface and configured to agitate the paste applied onto the stencil.

11. The screen printing apparatus of claim 10, further comprising a flood coater configured to be supported a predetermined offset distance above the stencil and actuatable to spread the paste across the stencil prior to the squeegee being wiped across the stencil.

12. The screen printing apparatus of claim 10, wherein the pulse source is at least one of an ultrasonic transducer device, an electromagnetic device, a piezoelectric device, and an electro mechanical device configured for vibrating or pulsating.

13. The screen printing apparatus of claim 10, wherein the pulse source comprises at least two pulse sources each configured to vibrate or pulsate in different directions relative to each other sequentially or simultaneously.

14. The screen printing apparatus of claim 10, wherein the pulse source is fixed relative to and proximate to the squeegee, but does not directly contact the squeegee, such that the pulse source is inserted or immersed in the paste on the stencil simultaneously when the squeegee is in contact the stencil.

15. The screen printing apparatus of claim 10, further comprising at least one of a control system and one or more actuation devices configured to control and actuate movement of at least one of the frame, stencil, squeegee, support surface, and pulse source, wherein the control system is configured to command one of the actuation devices to actuate the squeegee toward and contact the stencil and then to wipe the squeegee across the stencil, thereby transferring the paste thereon through the apertures of the stencil.

16. The screen printing apparatus of claim 10, wherein the screen printing apparatus is at least one of a rotary screen printing machine, a cylinder press screen printing machine, and a flatbed screen or stencil plate printing machine with the at least one pulse source attached thereto.

17. A method of screen printing, the method comprising:
inserting a substrate between a support surface and a first surface of a stencil with apertures formed therethrough;
applying paste to a second surface of the stencil, wherein the second surface is opposite of the first surface;
placing a squeegee in contact with the paste and the second surface of the stencil;
agitating the paste on the second surface of the stencil via vibration or pulsating of a pulse source; and
wiping the squeegee across at least a portion of the second surface of the stencil via actuation of at least one of the squeegee and the stencil relative to each other, thereby transferring the paste through the apertures of the stencil onto the substrate.

18. The method of claim 17, wherein the pulse source is fixed to at least one of and configured to vibrate at least one of the squeegee, a frame supporting the stencil, and a flood coater configured to spread the paste on the second surface of the stencil.

19. The method of claim 17, wherein the step of agitating the paste includes inserting or immersing the pulse source in the paste applied to the second surface of the stencil at a location proximate to but spaced apart from the squeegee while the squeegee is in contact with the paste and the second surface of the stencil.

20. The method of claim 17, wherein the squeegee is a component of at least one of a rotary screen printing machine, a cylinder press screen printing machine, and a flatbed screen or stencil plate printing machine.
